(19) United States
(12) Patent Application Publication
(10) Pub. No.: US 2016/0140461 A1
(43) Pub. Date: May 19, 2016

(54) SYSTEM AND METHOD FOR AUTOMATED ANALYTIC PROCESS FLOWS TO IMPROVE HEALTH OUTCOMES AND MANAGE HEALTHCARE COSTS

(71) Applicant: Xerox Corporation, Norwalk, CT (US)

(72) Inventors: MICHAEL D. SHEPHERD, ONTARIO, NY (US); DENNIS F. QUEBE, JR., AUSTIN, TX (US); JING ZHOU, PITTSFORD, NY (US); FAMING LI, SOLON, OH (US); JENNIE ECHOLS, CUMMING, GA (US); JINHUI YAO, PITTSFORD, NY (US); LINA FU, FAIRPORT, NY (US)

(21) Appl. No.: 14/547,706

(22) Filed: Nov. 19, 2014

(51) Int. Cl. G06Q 10/06

(52) U.S. Cl. CPC G06Q 10/063; G06Q 50/22

(57) ABSTRACT

A system and method for automating analytic processes to improve health outcomes and manage healthcare costs. Data associated with healthcare encounters with managed care organizations (MCOs) is acquired. Findings, predictions, and recommendations for tracking services provided by the MCOs are identified with analytic flows that are based on the data. Relations between the services provided by the MCOs and the healthcare encounters are identified. Utilization statistics are extracted from the data with the analytic processes. Information from the utilization statistics relevant to the healthcare encounters is output.

### BACKGROUND

Systems and methods herein generally relate to healthcare analytics, and more particularly, to methods for automating analytic process flows in order to improve health outcomes and manage healthcare costs.

Currently, there is a trend in U.S. State Medicaid offices to transition their members from a Fee-For-Service payment model to a Managed Care payment model. The Centers for Medicare and Medicaid Services (CMS) dictates that states provide better oversight of the Managed Care Organizations (MCO). Insights into patient data requires automated processes so that Medicaid directors can easily understand how each MCO and healthcare provider is performing from clinical, financial, and operational perspectives. Current analysis and workflow tools are manually driven, and require a Medicaid officer to spend many hours or days of analysis to answer a single question about their member population.

Medicaid requirements on the MCOs and healthcare providers include requests to generate hundreds of detailed reports for the Medicaid offices to process. Medicaid offices, in turn, generate hundreds of detailed reports for the federal CMS office. Typically, these reports are manually processed and scoured for opportunities to improve health outcomes and improve effective spending on Medicaid populations. In addition, the Medicaid office continuously tracks encounter claims to determine MCO reimbursement and set capitation rates.

### SUMMARY

According to an exemplary method herein, data associated with healthcare encounters with managed care organizations (MCOs) and healthcare providers is acquired. Analytic processes and flows for tracking services provided by the MCOs and healthcare providers are identified, based on the data. Relations between the services provided by the MCOs and healthcare providers and the healthcare encounters are identified. Utilization statistics are extracted from the data by the analytic processes. Information from the utilization statistics relevant to the healthcare encounters is output.

According to an exemplary method, medical data associated with patients' healthcare encounters with managed care organizations (MCOs) and healthcare providers is acquired. The medical data comprises relations between services provided by the MCOs and healthcare providers and the healthcare encounters and patient demographics. The medical data may also include claims data. The medical data may be combined with additional patient data such as clinical data or health information exchange (HIE) data. Analytical process suggestions are presented on a graphic user interface (GUI), based on predefined categories of concern for the MCOs. Selection is enabled on the GUI of analytic processes and flows from an existing library of analytical processes for tracking the services provided by the MCOs and healthcare providers. The analytic processes are based on clinical expertise. The processes are executed on the medical data. Utilization statistics are extracted from the medical data by the analytic processes and flows selected from the existing library of analytical processes. The utilization statistics are analyzed. Information relevant to the healthcare encounters is determined, based on the medical data. Findings, predictions, and/or recommendations based on the information are output on the GUI.

According to another exemplary method, a list of analytical processes is provided on a user interface. The analytical processes comprise methodologies of processing data previously stored in a library on a computerized storage device operatively connected to the user interface. A user selection of a user selected analytical process of the analytical processes is received through the user interface. Details of the user selected analytical process and available statistical findings producible by the user selected analytical process are displayed on the user interface. A user selection of a user selected statistical findings of the analytical processes is received through the user interface. A second analytical process of the analytical processes that should be used with the user selected analytical process of the analytical processes is automatically determined based on the user selected statistical findings using a computerized device operatively connected to the user interface. The second analytical process is displayed on the user interface as a suggestion for being combined with the user selected analytical process. The user selected analytical process is automatically combined with the second analytical process into an analytical flow using the computerized device based on the user accepting the suggestion through the user interface. The analytical flow is output from the computerized device.

According to a system herein, a centralized repository comprises medical data associated with patients' healthcare encounters with managed care organizations (MCOs) and healthcare providers and a library of analytical processes. The medical data may also include claims data. A server is operatively connected to the centralized repository. The server comprises a processor. A user interface is operatively connected to the processor. The user interface presents analytical process suggestions based on predefined categories of concern for the MCOs and receives requests for tracking the services provided by the MCOs and healthcare providers. A network interface connects the server with the centralized repository. The centralized repository stores medical data comprising relations between services provided by the MCOs and healthcare providers and the healthcare encounters and patient demographics. The processor enables selection, on the user interface, of analytic processes and flows from the library of analytical processes for tracking the services provided by the MCOs. The processor organizes the analytic processes into analytical flows based on clinical expertise. The processor extracts utilization statistics from the medical data using analytic processes selected from the library of analytical processes. The processor outputs information from the utilization statistics relevant to the healthcare encounters on the user interface. Upon receiving a request through the user interface, the processor analyzes the utilization statistics and outputs findings, predictions, and/or recommendations based on the information.

According to a computer system for automating analytic processes to improve health outcomes and manage healthcare costs, the computer system comprises a program product comprising a tangible computer readable storage medium having program code embodied therewith. The program code is readable and executable by a computer to provide an application to perform a method. According to the method, medical data associated with patients' healthcare encounters with managed care organizations (MCOs) and healthcare providers is acquired. The medical data comprises relations between services provided by the MCOs and the healthcare encounters and patient demographics. Analytic processes are identified for tracking the services provided by the MCOs. The medical data may also include claims data. The analytic processes are executed on the medical data. Utilization statistics are extracted from the medical data using the analytic processes. The utilization statistics are analyzed. Information relevant to the healthcare encounters is determined. Findings, predictions, and/or recommendations based on the information are output.

These and other features are described in, or are apparent from, the following detailed description.

### BRIEF DESCRIPTION OF THE DRAWINGS

Various examples of the systems and methods are described in detail below, with reference to the attached drawing figures, which are not necessarily drawn to scale and in which:

FIG. 1 is a block diagram of a network according to systems and methods herein;

FIGS. 2A and 2B are a flow diagram of exemplary automated analytic processes according to systems and methods herein;

FIGS. 3A and 3B illustrate an example of an analytic input page for designing analytic flows according to systems and methods herein;

FIGS. 4A and 4B illustrate an example of an analytic input page for designing analytic flows according to systems and methods herein;

FIGS. 5A and 5B illustrate an example of an analytic input page for designing analytic flows according to systems and methods herein;

FIG. 6 illustrates an example of a results page of findings from analytic processes and flows according to systems and methods herein;

FIG. 7 is a flow diagram illustrating methods herein;

FIG. 8 is a flow diagram illustrating methods herein;

FIG. 9 is a schematic diagram illustrating devices herein; and

FIG. 10 is a schematic diagram illustrating systems herein.

### DETAILED DESCRIPTION

For a general understanding of the features of the disclosure, reference is made to the drawings. In the drawings, like reference numerals have been used throughout to identify identical elements. While the disclosure will be described hereinafter in connection with specific devices and methods thereof, it will be understood that limiting the disclosure to such specific devices and methods is not intended. On the contrary, it is intended to cover all alternatives, modifications, and equivalents as may be included within the spirit and scope of the disclosure as defined by the appended claims.

A system of analytics and decision support devices is disclosed herein to automatically provide descriptive, predictive, and prescriptive insights based on healthcare encounter data and other related data, such as claims data. Analytic processes address a specific area of concern in healthcare for the Medicaid office, such as emergency department (ED) utilization or 30-day Hospital Readmission. Each process determines a set of relevant findings based on medical data. The basis of these findings leads to further analysis or a selection of recommendations. Analytic processes are grouped into analytic libraries corresponding to an area of concern. Analytic flows link the analytic processes into clinical workflows, which provide recommendations to answer user questions about the medical data. Further analysis may be performed by automatically sending the findings to a subsequent analysis in an analytic flow. After a full analytic flow is performed, recommendations may be provided for improved population health outcomes and healthcare costs.

Disclosed herein are methods and systems that provide a framework of analytics and decision support to automatically provide descriptive, prescriptive, and predictive insights in the public health analytics domain. Each analytic process determines a set of relevant findings based on medical claims data. Further analysis is performed automatically by sending the findings to a subsequent analysis module in the analytic flow. A final recommendation is provided at the end. Systems and methods described herein enable a unique combination of the clinical expert's intuitive knowledge used in current manual analysis approaches with the automation of specific analytic methods to form an insight and/or recommendation.

According to systems and methods herein, automated, guided advanced analytics for population health management orchestrates the analytic processes and business logic into analytic flows. The analytic flows may automatically provide findings, predictions, and recommendations to improve health outcomes and reduce costs. Systems and methods herein capture manual clinical analysis and thought processes into an automated system for decision support, leading to identification of driving factors and recommendations.

The system described herein automatically provides descriptive, predictive, and prescriptive insights based on healthcare encounter claims data and other related data. Libraries of analytics are used to solve problems in various areas of concern. Each analytic process reaches specific, relevant findings in a particular area of concern of the Medicaid office. An outcome of specific findings may lead either to further analysis or to concrete recommendations. If further analysis is required, an analytic flow will automatically connect the findings to the subsequent analysis. The result of the analytic flow produces concrete recommendations, which are provided by the system for real world action. These actions positively affect population health outcomes or reduce costs.

The analytics are executed over medical data. As used herein, medical data includes claims data, e.g., Medicaid members' encounter claims, fee-for-service claims, capitation claims, in addition to member data, provider data, clinical data, lab data, disease data, risk scores, etc. The analytics are structured into persistent studies, which can be repeatedly executed over a moving temporal window of medical data. The analytics are built to address the core concerns of state Medicaid offices (e.g., What are the characteristics of the Medicaid members that drive the highest costs in my state?).

The analytics are composed of specific processes for producing relevant findings. As previously mentioned, inclusive of running individual processes, the findings can be chained together into automated analytic flows. The chaining is enabled by encoding of knowledge of clinical decision-making into logical flows. In these logical flows, the findings of one specific process may be fed as input parameters into a subsequent analysis process. This process is repeated until concrete recommendations can be made to answer the concern or question. Additionally, branching in the flows may occur based on specific findings. The flow uses the finding results to dynamically select the subsequent process in the flow.

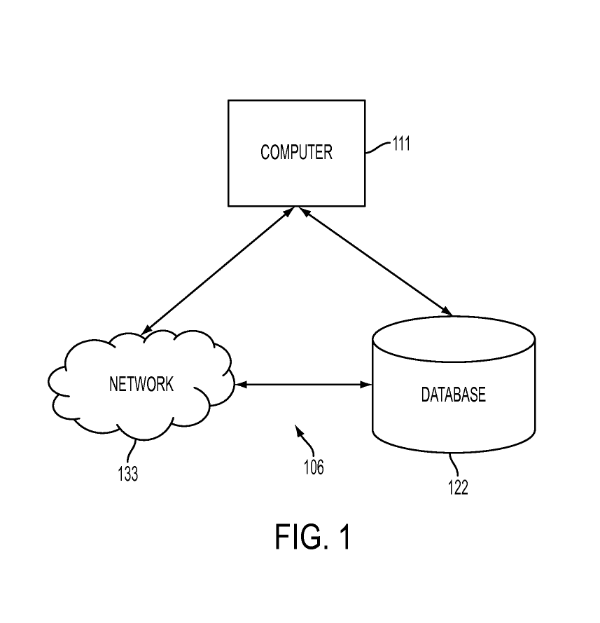

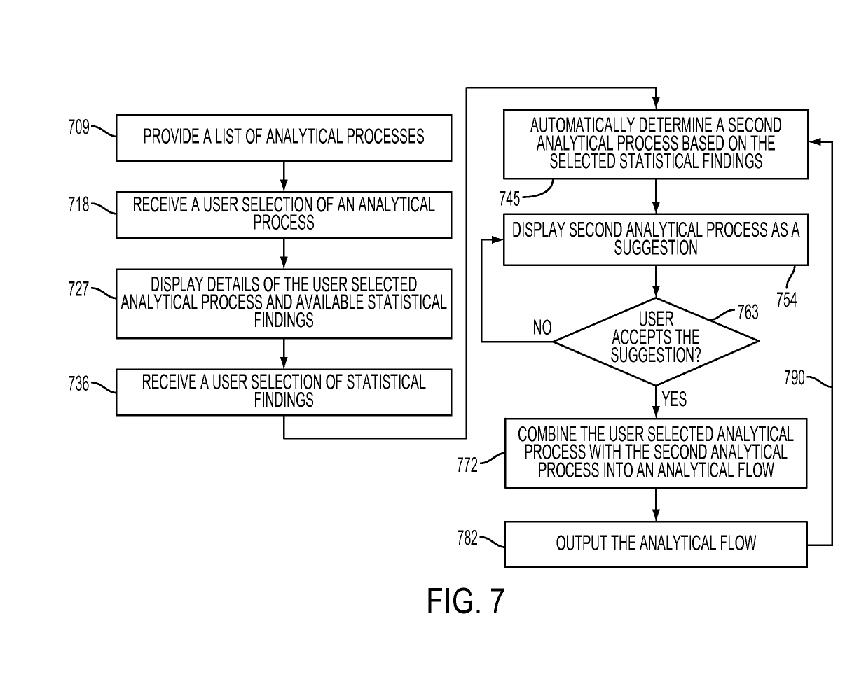

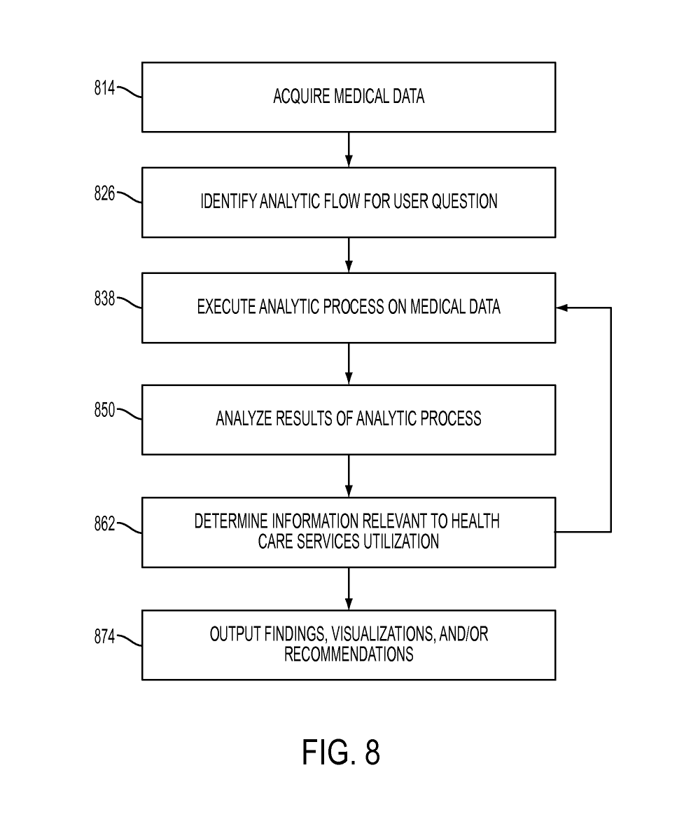

Referring now to the drawings, FIG. 1 is a general overview block diagram of a network, indicated generally as 106, for communication between a computer 111 and a database 122. The computer 111 may comprise any form of processor as described in further detail below. The computer 111 can be programmed with appropriate application software to implement the methods described herein. Alternatively, the computer 111 is a special purpose machine that is specialized for processing healthcare data and includes a dedicated processor that would not operate like a general purpose processor because the dedicated processor has application specific integrated circuits (ASICs) that are specialized for the handling of medical data processing operations (e.g., medical claims), processing analytic flows, tracking services provided by MCOs, etc. In one example, the computer 111 is a special purpose machine that includes a specialized processing card having unique ASICs for designing analytic flows, includes specialized boards having unique ASICs for input and output devices to speed network communications processing, a specialized ASIC processor that performs the logic of the methods described herein (such as the processing shown in FIGS. 7 and 8) using dedicated unique hardware, logic circuits, etc.

Database 122 includes any database or any set of records or data that the computer 111 desires to retrieve. Database 122 may be any organized collection of data operating with any type of database management system. The database 122 may contain matrices of datasets comprising multi-relational data elements.

The database 122 may communicate with the computer 111 directly. Alternatively, the database 122 may communicate with the computer 111 over network 133. The network 133 comprises a communication network either internal or external, for affecting communication between the computer 111 and the database 122. For example, network 133 may comprise a local area network (LAN) or a global computer network, such as the Internet.

According to systems and methods herein, components of a population health management decision support system may include:
Population Health Analytics Library
Population Health Analytics Processes
Automated Analytic Flows
Outputs and Recommendations

### Population Health Analytics Library

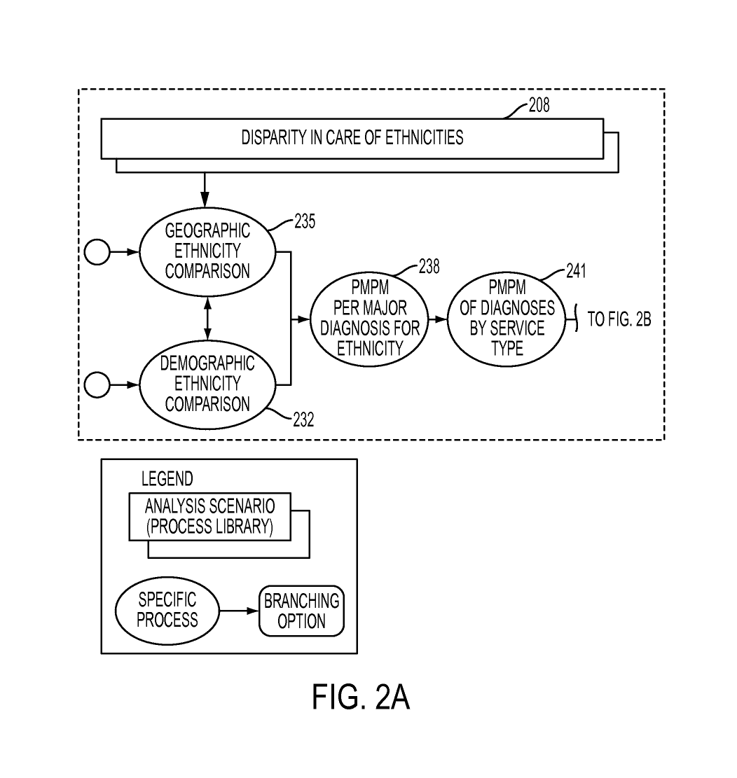

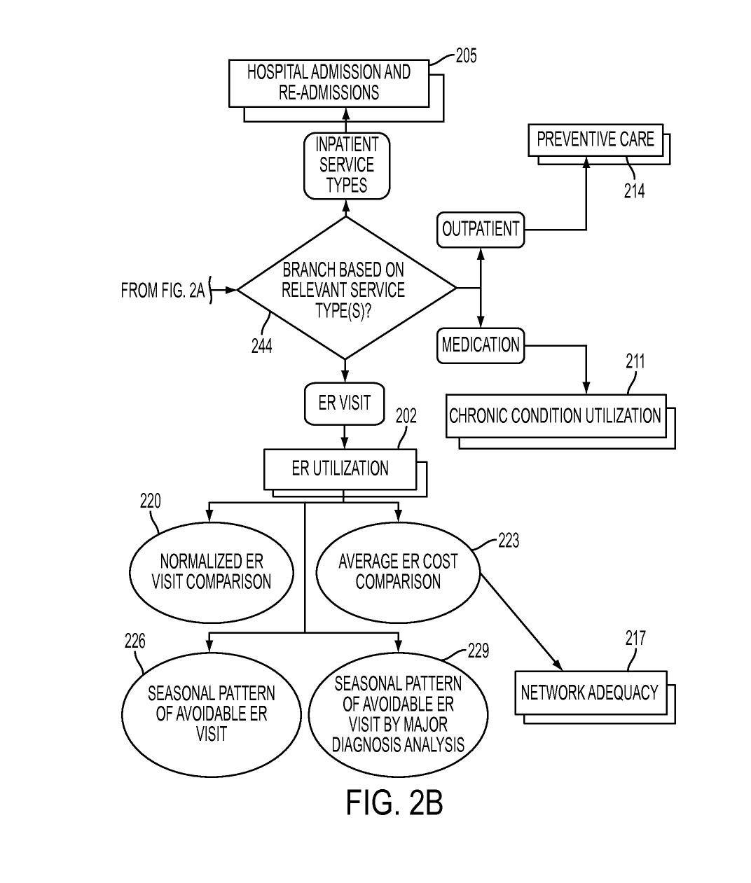

Medicaid offices and other MCO-monitoring organizations have healthcare overseers with specific questions in which to closely track the effectiveness of the MCOs. The questions are answered through analysis across various categories of concern in healthcare service utilization and patient needs. The categories of concern have significant impacts on both the cost and quality of healthcare provided. Referring to FIGS. 2A and 2B, examples of some categories of concern may include Emergency Department (ED) utilization 202, Hospital Admission and Re-admissions 205, Demographic Disparity in Care 208, Service Utilization by Members with Chronic Conditions 211, Preventive Care 214, Network Adequacy 217, etc. Each category corresponds to a library of analytic processes. The analytic processes are organized with clinical expertise into analytic flows. An analytic flow consisting of a sequence of specific analytic processes can provide findings, predictions, and recommendations for specific questions. For example, a Medicaid director may ask the question:
What are the characteristics of the Medicaid members that drive the highest costs in my state?
   According to systems and methods herein, an automated analytic flow may reveal that . . .
Medium-risk members with type-2 diabetes are experiencing a high ratio of avoidable emergency department (ED) visits as compared to non-avoidable ED visits. Access to primary care in the top three counties is a major factor. Recommend increasing the number of primary care providers (PCPs) in these three counties.

### Population Health Analytics Processes

For each category of concern, an analytics process library is composed of specific analytic processes that determine statistically significant findings, predictions, and recommendations in that category. For example, in ED Utilization 202, an analytic process may find statistically significant ratios of avoidable-to-non-avoidable ED visits for various populations. Under the category of ED utilization 202, specific processes may measure normalized ED visit comparisons 220, average ED cost comparisons 223, seasonal patterns of avoidable ED visits 226, and seasonal patterns of avoidable ED visits by major diagnostic analysis 229. Under the category of Demographic Disparity in Care 208, specific processes may compare demographic data by ethnicity 232 and/or compare geographic data by ethnicity 235. The ethnicity comparisons 232, 235 may provide results, such as relevant ethnicities in particular counties for further analysis with the analytic process Per-Member-Per-Month (PMPM) for major diagnoses codes (MDC) by ethnicity 238. Further analysis could then be performed on relevant MDC results with the analytic process PMPM of diagnoses per service type 241.

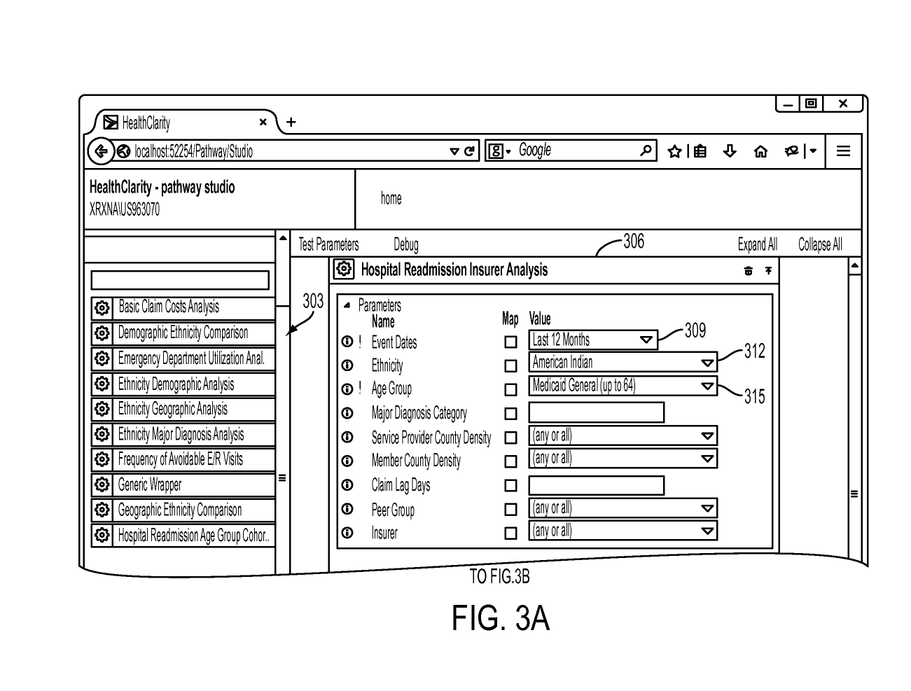

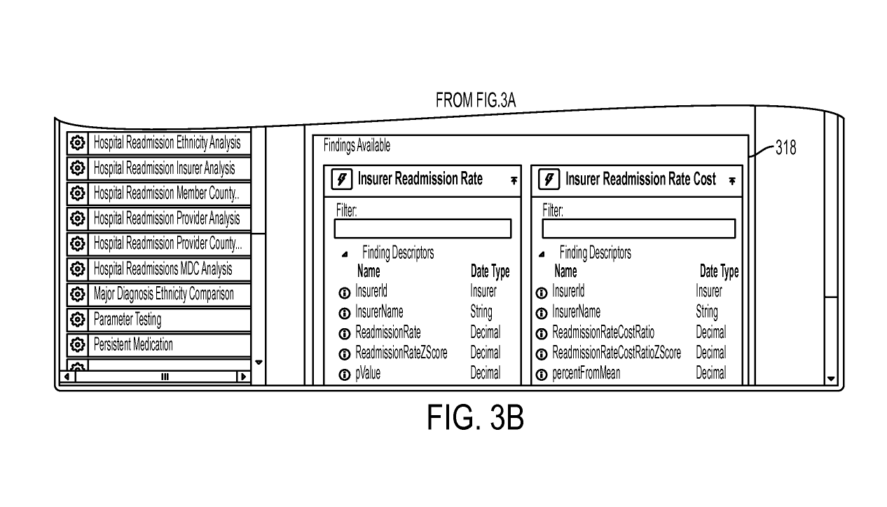

Each analytic process may be provided with input parameters with which to run the analysis, as further described below with reference to FIGS. 3A, 3B, 4A, 4B, 5A, and 5B. Each process outputs the raw measurements for consumption by another process or an end-user (e.g., for Male Type-2 diabetics of ages 18-34, MCO 1 has a ratio of 22% avoidable-to-non-avoidable, MCO 2 has a ratio of 15%, MCO 3 has a ratio of 17%, etc.). According to systems and methods herein, the raw measurements may be tested for and reported with statistical relevance (e.g., p-values) and confidence intervals. In particular, outliers that warrant further analysis may be specifically identified.

An exemplary health analytics process concerning Geographic Ethnicity Comparison across the Native American population is illustrated in Table 1. The analysis assesses the Total PMPM cost of maintaining a Native American member as compared to all other ethnicities. Input parameters may include the reporting period of claims, specific chronic conditions, age group cohorts, etc. A ratio is determined for outspending or underspending on the population groups. Exemplary process output is shown in Table 1. Line 1 can be interpreted as: In Sierra County, MCO 1's ratio of PMPM spent on the American Indian population as compared to all other ethnicities is 10.49. The PMPM spending on the American Indian population is $2,015.44 and all other ethnicity PMPM spending is $192.04. The PMPM spending on the American Indian population of $2,015.44 in Sierra County is strongly above the population mean of $236.19.

TABLE 1

| | | | Non- | | Out- |
|---|---|---|---|---|---|
| | | Native_{—} | Native_{—} | County | spend |
| Ethnicity | MCO | PMPM ($) | PMPM ($) | Name | Ratio |
| American Indian | MCO-1 | 2015.44 | 192.04 | Sierra | 10.49 |
| American Indian | MCO-3 | 1281.28 | 155.36 | De Baca | 8.24 |
| American Indian | MCO-3 | 667.63 | 170.97 | Roosevelt | 3.90 |
| American Indian | MCO-1 | 372.78 | 120.98 | Union | 3.08 |
| American Indian | MCO-4 | 701.56 | 228.22 | Eddy | 3.07 |
| | | 1007.74 | 173.51 | | |

### Automated Analytic Flows

A web-based analytic flows designer and integrated process orchestration engine provide for the creation and execution of analytic flows that compose the population health management processes. Analytic flows are built with clinical expertise to arrive at findings, predictions, and recommendations to specific queries of the system. The Flow uses conditional branching and rules to provide the flexible composition of existing processes and their libraries to deliver more findings and insights, and thereby provides better decision support to the users.

In the Automated Analytics Flow, the outputs of relevant findings from one or more processes are connected as input parameters to one or more subsequent processes. The flow logic and decision nodes provide the connection points in the flows. Branching points may direct the analysis based on the findings. These branching points alter the execution sequence of the flows according to some pre-defined branching rules provided by clinical experts.

The findings from an analysis in one category of concern may lead to additional analysis in other categories of concern. In the example illustrated in FIGS. 2A and 2B, an analysis concerning Disparity in Care 208 may lead to one or more analyses dealing with ED Utilization 202, which may lead to one or more analyses concerning Network Adequacy 217.

Processes and their libraries are the unit components, which a clinical expert can use to design analytic flows. A particular analytics solution is designed with pre-orchestrated (pre-defined) flows that build in the clinical logic for connecting processes and arriving at identification of findings, predictions, and recommendations. Additionally, a solution can provide a means for a clinical expert to design new flows and modifying existing flows that meet the needs of the users. The design of flows provide for the re-use of processes and their libraries.

For example, as illustrated in FIGS. 2A and 2B, a Medicaid director may want to learn of recommendations to improve health outcomes for Native Americans in their state. The automated flow shown in FIGS. 2A and 2B would provide the necessary analytics to accomplish this.
The director would start the flow with processes that identify problematic demographic and geographic Native American populations by analyzing demographic data by ethnicity 232 and analyzing geographic data by ethnicity 235.
The resulting populations (e.g. Female Native Americans of ages 18-34) would then be provided to a process that identified the top diagnoses driving the PMPM costs of those populations by ethnicity, as shown at 238.
The resulting diagnoses would then be provided to a process that identifies which service types were utilized in those cases, as shown at 241.
A decision point would be reached, at 244. Based on the services types utilized from the disparity in care analysis, the flow would automatically direct more detailed analysis for ED utilization 202, Hospital Admission 205, Preventive Care 214, etc. In the above example, further analysis for ED utilization 202 is performed.
A cost comparison process may then find, for example, that higher than average costs in ED utilization 202 are identified in 3 counties, such as shown in Table 1.
A series of processes concerning Network Adequacy 217 are then executed, including a geographic analysis of access to care.

FIGS. 3A, 3B, 4A, 4B, 5A, and 5B illustrate examples of input pages for designing analytic flows through the linking of analytic processes, as shown at 303. For example, in FIGS. 3A and 3B, the analytic process is for Hospital Readmission by Insurer 306. In this exemplary analytic flow, there are three values set as input parameters: Event Dates 309, Ethnicity 312, and Age Group 315. The analytic process for Hospital Readmission by Insurer 306 has predetermined ‘Findings Available’, as shown by box 318. In this example, the ‘Findings Available’ box 318 illustrates a schema of the output of the analysis. That is, in response to user selection of an analytic process 303, the system automatically lists some statistical findings that are available, if the user would like to see them, and displays them in the ‘Findings Available’ box 318. The user may select some or all of these findings.

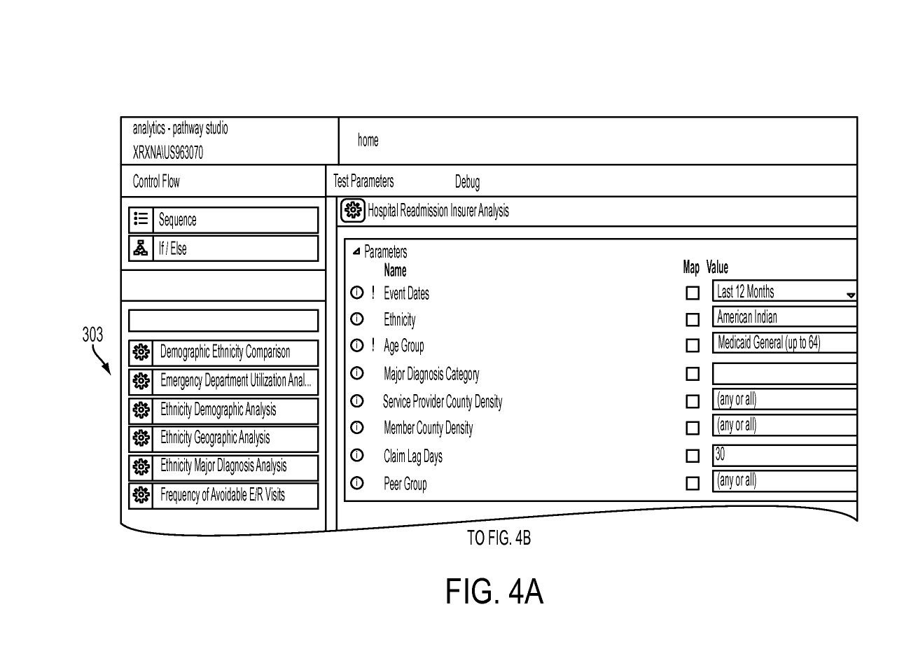

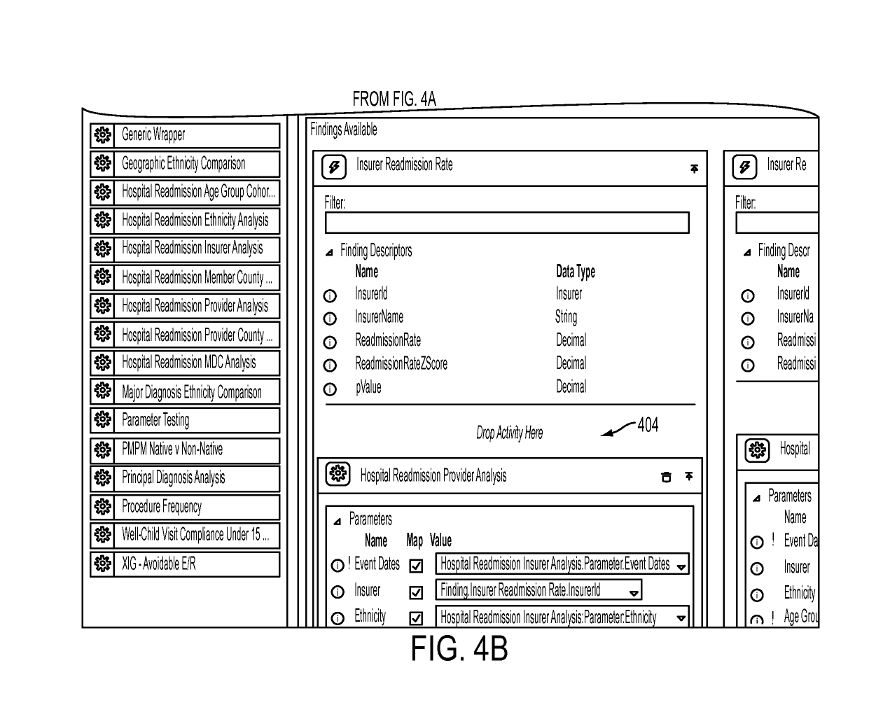

In FIGS. 4A and 4B, a second analytic process for Hospital Readmission by Provider 404 may be mapped from the same input parameters. In other words, an additional analytical process may be automatically identified (Hospital Readmission by Provider 404) based upon the combination of the statistical findings that the user selected and the data resulting from a combination of those findings.

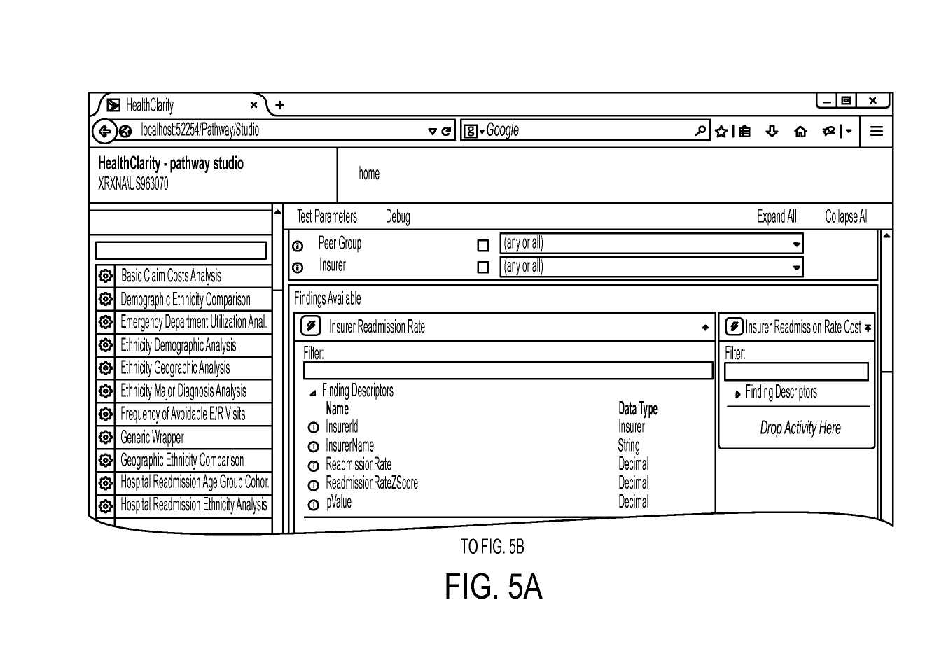

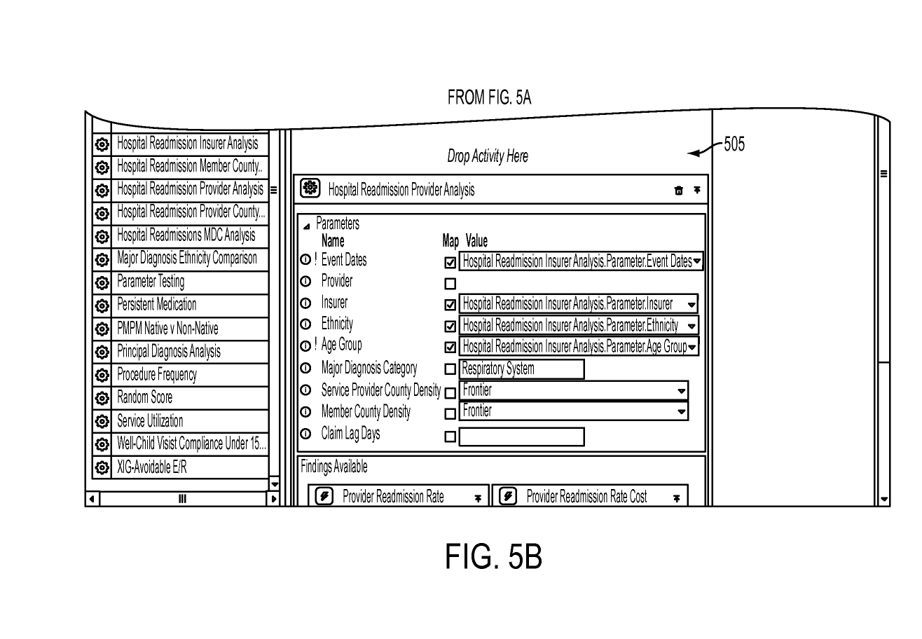

In subsequent processes, input parameters can tie back 505 to the outputs from one of the previous processes in the flow, and/or the input parameters can be set with new values as shown in FIGS. 5A and 5B. Furthermore, since the process is iterative, the user can change the selection of the analytic process 303 in order to refine the statistical findings that are available.

The user interface, such as illustrated in FIGS. 3A, 3B, 4A, 4B, 5A, and 5B, assists the user in establishing analytic flows by providing statistical findings and then using the statistical findings selected by the user to suggest to the user additional analytic process that could be added to the analytical flow. As would be understood by one ordinarily skilled in the art, the user interface may comprise a graphic user interface (GUI).

### Outputs and Recommendations

Based on the analysis of Network Adequacy 217, it may be found, for example, that two counties lack sufficient access to pediatricians, and one county lacks sufficient access to urgent care facilities. These findings are reported back to the Medicaid director with recommendations. Example recommendations may include adding incentives for the creation of additional care facilities, and/or encouraging members to move from one MCO with insufficient pediatricians to another MCO that provides improved access to care.

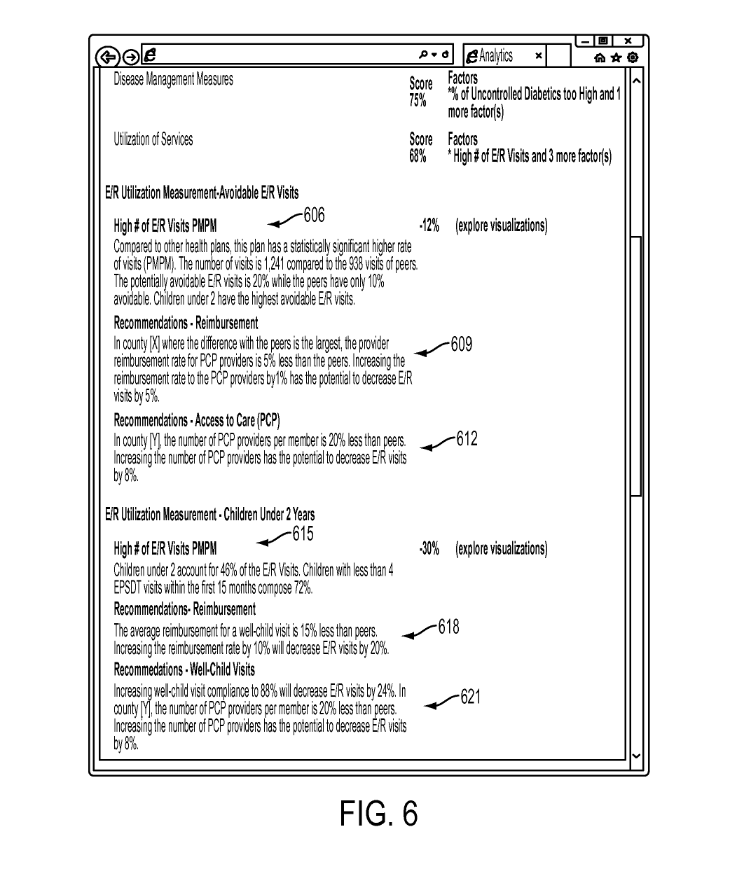

For example, FIG. 6 illustrates an example of an outputs page from analytic processes, and includes recommendations. In this example, there is a significantly higher rate of emergency room visits PMPM 606. Accordingly, the system recommends changes in rates for PCPs 609 and increasing the number of PCPs 612. Other exemplary findings include a high number of emergency room visits by children 615. Accordingly, the system recommends changes in reimbursement rates for well-child visits to PCPs 618 and increasing the number of PCPs 621.

As described above, a decision support system is disclosed that uses statistical and predictive analysis of medical claims within customizable analytic flows to automatically provide a user of the system with the driving factors and recommendations to improve health outcomes and reduce costs. The processes described enables population health management that leverages specific analytic processes in an orchestrated fashion. The system enables a platform that offers analytics as a service that automates the knowledge about healthcare services utilization and its patients.

According to the present disclosure, the analytical processes are organized into analytical flows based on clinical expertise. Systems and methods herein help the user establish or revise analytical flows from a library of existing analytical processes. This is accomplished by looking at what statistical findings the user has interests in, based on an input question. Then the statistical findings that the user selected are used to automatically predict what additional analytical processes could be added to the analytical flow, based on the data resulting from analysis of those statistical findings. Upon the addition of a new analytical process, new available findings are presented and the process repeats to continue to add analytical processes to the analytical flow being created. In other words, the analytic flows are built with clinical expertise to arrive at findings, predictions, and recommendations to specific queries of the system. The Flow uses conditional branching and rules to provide the flexible composition of existing processes and their libraries in order to deliver more findings and insights, and thereby provides better decision support to the users.

As would be understood by one ordinarily skilled in the art, the processes described herein cannot be performed by humans alone (or one operating with a pen and a pad of paper). Instead, such processes can only be performed by a machine. Specifically, processes such as data analysis, data security (such as encryption), electronic transmission of data over networks, etc., require the utilization of different specialized machines. For example, the automatic selection of statistical findings performed by the user device cannot be performed manually (because it would take decades or lifetimes) and is integral with the processes performed by methods herein. Further, such machine-only processes are not mere “post-solution activity” because each process determines a set of relevant findings based on medical data. The basis of these findings leads to further analysis or a selection of recommendations, and such data may be further processed according to selected flows. Similarly, the selection and display of various analytic processes utilize special-purpose equipment (processors, routers, switches, etc.) that is distinct from a general-purpose processor. Also, the data selection and analysis is integral with the process performed by the methods herein, and is not mere post-solution activity, because the flow processes of the methods herein rely upon the previous analytic processes, and cannot be performed without the libraries of existing analytical processes. In other words, these various machines are integral with the methods herein because the methods cannot be performed without the machines (and cannot be performed by humans alone).

Additionally, the methods herein solve many highly complex technological problems. For example, as mentioned above, providers suffer from the technological problem of not being fully capable of effectively analyzing medical data in a process that can be repeatedly executed over a moving temporal window. Methods herein solve this technological problem by automatically designing analytic flows using processes from a library of analytical process. Results from any analytic process may be used as input for further processing. This reduces the amount of time and processing capability that a provider must utilize. By granting such benefits to providers, the methods herein reduce the amount and complexity of hardware and software needed to be purchased, installed, and maintained by providers, thereby solving a substantial technological problem that providers experience today. Accordingly, the technology of the user device can be substantially simplified, thereby reducing cost, weight, size, etc., and providing many substantial technological benefits to the user.

FIG. 7 illustrates the processing of an exemplary method for creating a process flow according to systems and methods herein. At 709, a list of analytical processes is provided on a user interface. The analytical processes comprise methodologies of processing data previously stored in a library on a computerized storage device operatively connected to the user interface. A user selection of a user selected analytical process of the analytical processes is received through the user interface, at 718. At 727, details of the user selected analytical process and available statistical findings producible by the user selected analytical process are displayed on the user interface. A user selection of a user selected statistical findings of the analytical processes is received through the user interface, at 736. A second analytical process of the analytical processes that should be used with the user selected analytical process of the analytical processes is automatically determined, at 745. The second analytic process is determined based on the user selected statistical findings using a computerized device operatively connected to the user interface. At 754, the second analytical process is displayed on the user interface as a suggestion for being combined with the user selected analytical process. If, at 763, the user accepts the suggestion through the user interface, the user selected analytical process is automatically combined with the second analytical process into an analytical flow using the computerized device, at 772. The analytical flow is output from the computerized device, at 781. If, at 763, the user rejects the suggestion, a different second analytical process of the analytical processes is determined based on the user selected statistical findings, as shown at 754. The method can repeatedly determine additional analytical processes that should be used with the analytical flow, as shown by arrow 790, to produce revised analytical flows.

FIG. 8 is a flow diagram illustrating the processing flow of an exemplary method according to systems and methods herein. The method is useful for automating analytic processes to improve health outcomes and manage healthcare costs. At 814, medical data associated with patients' healthcare encounters with managed care organizations (MCOs) and healthcare providers is acquired. The medical data comprises relations between services provided by the MCOs and healthcare providers and the healthcare encounters and patient demographics. The medical data may also include claims data. At 826, an analytic flow is identified for answering a particular question about the healthcare services provided by the MCOs and healthcare providers. The analytic flows are composed of analytics processes and business logic, which operate on the medical data. Analytic processes are statistical models and predictive models, which operate on the medical data, at 838, to analyze MCO service utilization and their member populations. The analytic process results are analyzed, at 850. Information relevant to the healthcare services utilization is determined, at 862. Analysis may continue in another analytic process in the analytic flow until, at 874, findings, predictions, and/or recommendations, based on the information, are output.

Aspects of the present disclosure are described herein with reference to flowchart illustrations and/or block diagrams of methods, apparatus (systems), and computer program products according to various systems and methods. It will be understood that each block of the flowchart illustrations and/or two-dimensional block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

According to a further system and method herein, an article of manufacture is provided that includes a tangible computer readable medium having computer readable instructions embodied therein for performing the steps of the computer implemented methods, including, but not limited to, the method illustrated in FIGS. 7 and 8. Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. Any of these devices may have computer readable instructions for carrying out the steps of the methods described above with reference to FIGS. 7 and 8.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

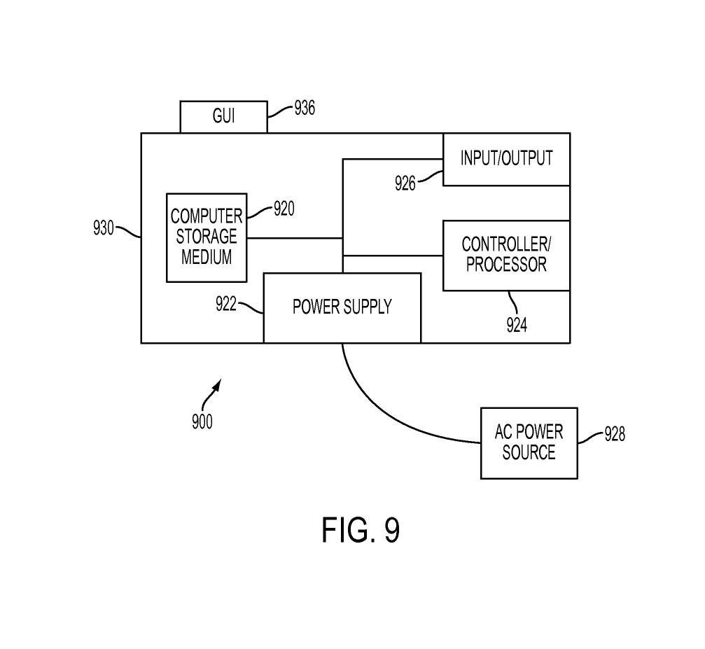

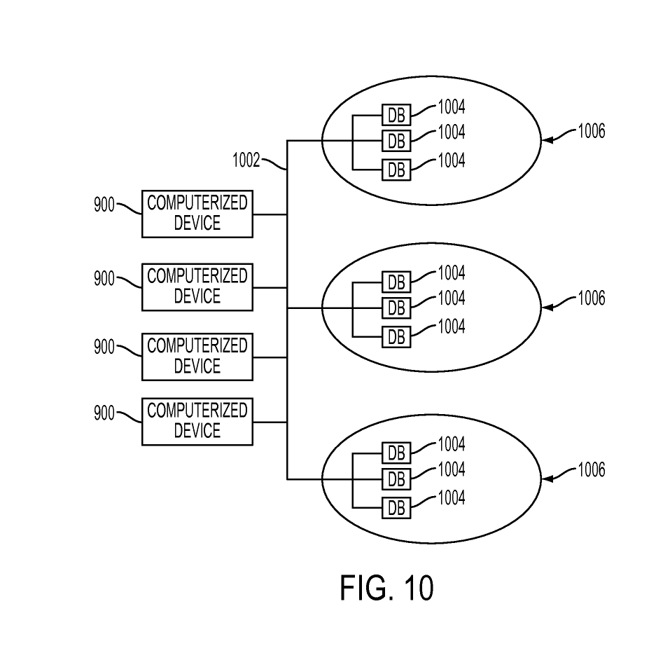

FIG. 9 illustrates a computerized device 900, which can be used with systems and methods herein and can comprise, for example, a personal computer, a portable computing device, etc. The computerized device 900 includes a controller/processor 924 and a communications port (input/output device 926) operatively connected to the controller/processor 924. As described above, the controller/processor 924 may also be connected and to a computerized network 1002 external to the computerized device 900, such as shown in FIG. 10. In addition, the computerized device 900 can include at least one accessory functional component, such as a graphic user interface assembly (GUI) 936 that also operates on the power supplied from the external power source 928 (through the power supply 922).

The Input/Output device 926 is used for communications to and from the computerized device 900. The controller/processor 924 controls the various actions of the computerized device. A non-transitory computer storage medium 920 (which can be optical, magnetic, capacitor based, etc.) is readable by the controller/processor 924 and stores instructions that the controller/processor 924 executes to allow the computerized device 900 to perform its various functions, such as those described herein. Thus, as shown in FIG. 9, a body housing 930 has one or more functional components that operate on power supplied from the external power source 928, which may comprise an alternating current (AC) power source, to the power supply 922. The power supply 922 can comprise a power storage element (e.g., a battery) and connects to an external power source 928. The power supply 922 converts the external power into the type of power needed by the various components.

In case of implementing the systems and methods herein by software and/or firmware, a program constituting the software may be installed into a computer with dedicated hardware, from a storage medium or a network, and the computer is capable of performing various functions if with various programs installed therein.

In the case where the above-described series of processing is implemented with software, the program that constitutes the software may be installed from a network such as the Internet or a storage medium such as the removable medium.

Those skilled in the art would appreciate that the storage medium is not limited to a peripheral device having the program stored therein, which is distributed separately from the device for providing the program to the user. Examples of a removable medium include a magnetic disk (including a floppy disk), an optical disk (including a Compact Disk-Read Only Memory (CD-ROM) and a Digital Versatile Disk (DVD)), a magneto-optical disk (including a Mini-Disk (MD) (registered trademark)), and a semiconductor memory. Alternatively, the computer storage medium 920 may be a hard disk, or the like, which has the program stored therein and is distributed to the user together with the device that contains them.

As will be appreciated by one skilled in the art, aspects of the devices and methods herein may be embodied as a system, method, or computer program product. Accordingly, aspects of the present disclosure may take the form of an entirely hardware system, an entirely software system (including firmware, resident software, micro-code, etc.) or an system combining software and hardware aspects that may all generally be referred to herein as a ‘circuit’, ‘module, or ‘system.’ Furthermore, aspects of the present disclosure may take the form of a computer program product embodied in one or more computer readable medium(s) having computer readable program code embodied thereon.

Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a Read Only Memory (ROM), an Erasable Programmable Read Only Memory (EPROM or Flash memory), an optical fiber, a magnetic storage device, a portable compact disc Read Only Memory (CD-ROM), an optical storage device, a “plug-and-play” memory device, like a USB flash drive, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods, and computer program products according to various devices and methods herein. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As shown in FIG. 10, exemplary systems and methods herein may include various computerized devices 900 and databases 1004 located at various different physical locations 1006. The computerized devices 900 and databases 1004 are in communication (operatively connected to one another) by way of a local or wide area (wired or wireless) computerized network 1002.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

The terminology used herein is for the purpose of describing particular examples of the disclosed structures and methods and is not intended to be limiting of this disclosure. For example, as used herein, the singular forms ‘a’, ‘an’, and ‘the’ are intended to include the plural forms as well, unless the context clearly indicates otherwise. Additionally, as used herein, the terms ‘comprises’, ‘comprising’, and/or ‘including’, when used in this specification, specify the presence of stated features, integers, steps, operations, elements, and/or components, but do not preclude the presence or addition of one or more other features, integers, steps, operations, elements, components, and/or groups thereof. Further, the terms ‘automated’ or ‘automatically’ mean that once a process is started (by a machine or a user), one or more machines perform the process without further input from any user.

The corresponding structures, materials, acts, and equivalents of all means or step plus function elements in the claims below are intended to include any structure, material, or act for performing the function in combination with other claimed elements as specifically claimed. The descriptions of the various devices and methods of the present disclosure have been presented for purposes of illustration, but are not intended to be exhaustive or limited to the devices and methods disclosed. Many modifications and variations will be apparent to those of ordinary skill in the art without departing from the scope and spirit of the described devices and methods. The terminology used herein was chosen to best explain the principles of the devices and methods, the practical application or technical improvement over technologies found in the marketplace, or to enable others of ordinary skill in the art to understand the devices and methods disclosed herein.

It will be appreciated that the above-disclosed and other features and functions, or alternatives thereof, may be desirably combined into many other different systems or applications. Those skilled in the art may subsequently make various presently unforeseen or unanticipated alternatives, modifications, variations, or improvements therein, which are also intended to be encompassed by the following claims. Unless specifically defined in a specific claim itself, steps or components of the systems and methods herein should not be implied or imported from any above example as limitations to any particular order, number, position, size, shape, angle, color, temperature, or material.

What is claimed is:

1. A method, comprising:
acquiring data associated with healthcare encounters with managed care organizations (MCOs);
identifying analytic processes and flows for tracking services provided by said MCOs, based on said data;
identifying relations between said services provided by said MCOs and said healthcare encounters;
extracting utilization statistics from said data with said analytic processes and flows; and
outputting information from said utilization statistics relevant to said healthcare encounters.

2. The method according to claim 1, said data associated with said healthcare encounters comprising fee-for-service claims, capitation claims, member data, provider data, clinical data, lab data, disease data, and risk scores.

3. The method according to claim 1, said data associated with said healthcare encounters comprising data associated with encounters provided by healthcare providers.

4. The method according to claim 1, further comprising:
analyzing said data associated with said healthcare encounters, each analytic process of said analytic processes addressing a specific area of concern in healthcare.

5. The method according to claim 1, further comprising:
automatically recommending actions to improve health outcomes and reduce costs based on said information output from said utilization statistics.

6. The method according to claim 1, further comprising:
using said information from said analytics processes as input to subsequent analytic processes.

7. A method, comprising:
acquiring medical data associated with patients' healthcare encounters with managed care organizations (MCOs), said medical data comprising relations between services provided by said MCOs and said healthcare encounters and patient demographics;
presenting, on a graphic user interface (GUI), analytical process suggestions based on predefined categories of concern for said MCOs;
enabling selection, on said GUI, of analytic processes and flows from an existing library of analytical processes for tracking said services provided by said MCOs, said analytic processes being based on clinical expertise;
extracting utilization statistics from said medical data with said analytic processes and flows selected from said existing library of analytical processes;
analyzing said utilization statistics and determining information relevant to said healthcare encounters, based on said medical data; and
outputting, on said GUI, analysis or recommendations based on said information.

8. The method according to claim 7, said medical data associated with said patients' healthcare encounters comprising fee-for-service claims, capitation claims, member data, provider data, clinical data, lab data, disease data, and risk scores.

9. The method according to claim 7, said medical data associated with said patient's healthcare encounters comprising medical data associated with said patient's encounters provided by healthcare providers.

10. The method according to claim 7, further comprising:
analyzing said medical data associated with said patients' healthcare encounters, each analytic process of said analytic processes selected from said existing library of analytical processes addressing a specific area of concern in healthcare.

11. The method according to claim 7, each analytic process of said analytic processes selected from said existing library of analytical processes determining a set of relevant findings, predictions, and recommendations based on said medical data.

12. The method according to claim 7, further comprising:
automatically recommending actions to improve health outcomes and reduce costs based on said analysis or recommendations.

13. The method according to claim 7, further comprising:
using said information from said analytic processes as input to subsequent analytic processes selected from said existing library of analytical processes.

14. A method comprising:
providing a list of analytical processes on a user interface, said analytical processes comprising methodologies of processing data previously stored in a library on a computerized storage device operatively connected to said user interface;
receiving a user selection of a user selected analytical process of said analytical processes through said user interface;
displaying details of said user selected analytical process and available statistical findings producible by said user selected analytical process on said user interface;
receiving a user selection of a user selected statistical findings of said analytical processes through said user interface;
automatically determining a second analytical process of said analytical processes that should be used with said user selected analytical process of said analytical processes based on said user selected statistical findings using a computerized device operatively connected to said user interface;
displaying said second analytical process on said user interface as a suggestion for being combined with said user selected analytical process;
automatically combining said user selected analytical process with said second analytical process into an analytical flow using said computerized device based on said user accepting said suggestion through said user interface; and
outputting said analytical flow from said computerized device.

15. The method according to claim 14, further comprising repeatedly determining an additional analytical process of said analytical processes that should be used with said analytical flow;
displaying said additional analytical process on said user interface as a suggestion for being combined with said analytical flow;
automatically combining said user selected analytical process with said analytical flow using said computerized device based on said user accepting said suggestion of said additional analytical process through said user interface; and
outputting a revised analytical flow from said computerized device.

16. The method according to claim 14, further comprising automatically determining a different second analytical process of said analytical processes based on said user rejecting said suggestion through said user interface.

17. The method according to claim 14, further comprising:
acquiring medical data associated with patients' healthcare encounters with managed care organizations (MCOs), said medical data comprising relations between services provided by said MCOs and said healthcare encounters and patient demographics,
said medical data associated with said patients' healthcare encounters comprising fee-for-service claims, capitation claims, member data, provider data, clinical data, lab data, disease data, and risk scores,
said suggestion of analytical processes being based on predefined categories of concern for said MCOs.

18. The method according to claim 17, further comprising:
extracting utilization statistics from said medical data with said analytic processes selected from said library;
analyzing said utilization statistics and determining information relevant to said healthcare encounters, based on said medical data; and
outputting, on said user interface, analysis or recommendations based on said information.

19. The method according to claim 17, further comprising:
analyzing said medical data associated with said patients' healthcare encounters, each analytic process of said analytic processes selected from said library addressing a specific area of concern in healthcare.

20. The method according to claim 17, each analytic process of said analytic processes selected from said library determining a set of relevant findings, predictions, and recommendations based on said medical data.
